(19) United States
(12) Patent Application Publication
(10) Pub. No.: US 2003/0101781 A1
(43) Pub. Date: Jun. 5, 2003

(54) Motor vehicle door lock system

(76) Inventors: Edgar Budzynski, Dortmund (DE); Matthias Koerwer, Wuppertal (DE); Stephan Schmitz, Koln (DE)

Correspondence Address: NIXON PEABODY, LLP, 8180 GREENSBORO DRIVE, SUITE 800, MCLEAN, VA, 22102, US

(21) Appl. No.: 10/111,776

(22) PCT Filed: Nov. 29, 2000
(86) PCT No.: PCT/EP00/11905

(51) Int. Cl. B60R 25/04

(52) U.S. Cl. 70/239

(57) ABSTRACT

A motor vehicle door lock system, an outside door handle arrangement, and a process for controlling a motor vehicle door lock system are proposed. For simple, economical sensing of the actuation of an outside door handle, a first signal is detected when the outside door handle is touched, and when the outside door handle is released a second signal is detected, the signals being evaluated as the start and end of actuation of the outside door handle. Alternatively or in addition, it is provided that a pressure load on the outside door handle is detected for locking the assigned motor vehicle door lock.

This invention relates to a motor vehicle door lock system as claimed in the preamble of claim 1 or 5, an outside door handle arrangement as claimed in the preamble of claim 24, and a process for controlling a motor vehicle door lock system as claimed in the preamble of claim 32 or 37.

Electromechanical motor vehicle door lock systems are known. After unlocking, for example by means of radio remote control, the operator pulls on the outside door handle of the motor vehicle door, an assigned motor vehicle door lock being opened by the outside door handle delivering a control signal to the opening drive to raise the detent pawl of the motor vehicle door lock.

DE 197 52 974 A1 which forms the point of departure of this invention discloses a motor vehicle door lock system with an outside door handle which has a contact electrode on the actuating lever for detecting contact or actuation. Detection of actuation is not detailed and is used to trigger an authorization query. The assigned motor vehicle door lock is however opened mechanically by pulling the actuating lever.

The object of this invention is to devise a motor vehicle door lock system, an outside door handle arrangement for a motor vehicle door lock system, and a process for controlling a motor vehicle door lock system, so that preferably without moving parts, especially reliable sensing of activation of the outside door handle can take place easily and economically, especially to trigger an opening drive and/or a central interlock system or locking drive.

The aforementioned object is achieved by a motor vehicle door lock system as claimed in claim 1 or 5, an outside door handle arrangement as claimed in claim 24 or a process as claimed in claim 32 or 37. Advantageous developments are the subject matter of the dependent claims.

The underlying idea of this invention is to detect and evaluate a first signal and a second signal of a sensor and the start and end of actuation of the outside door handle. The sensor produces a first signal upon touching or actuation—therefore when the hand of the operator comes into contact with the outside door handle or sensor. When the outside door handle is released a second signal is produced by the sensor and it is generally opposite the first signal, therefore especially exhibits opposite polarity or an opposite change; this facilitates unambiguous detection.

In the approach as claimed in the invention, it is sufficient if the sensor or its sensor element reacts only to changes. With constant or uniform touching of the outside door handle or pulling on the outside door handle the sensor therefore need not make available any (further) signal. Rather, the sensor during this time can again show the same signal, as with the outside door handle released. This leads to several advantages.

The detection or evaluation of the first and second signal as claimed in the invention allows especially reliable detection of actuation of the outside door handle. Outside door handles in this sense can be not only bow-shaped handles, but also flap-shaped handles.

The approach as claimed in the invention enables use of sensor elements which react simply to changes.

In particular there is a piezoelement as the sensor element. Here it is a piezocrystal which upon deformation by charge displacement produces an electrical voltage, especially perpendicular on its sides to the direction of deformation. Preferably a capacitive evaluation takes place, therefore detection of the charge displacement or capacitance changes when the piezoelement is deformed. But for example resistive evaluation is also possible.

The sensor element is made immovable or stationary—therefore not as a moving switch or button—preferably such that loading leads to deformation paths which are as much as possible only minimal, especially only in the micron range, so that upon contact and/or actuation, especially pulling of the outside door handle, and/or when pressing on the outside door handle, deformation or motion cannot be sensed by the operator. This property can be implemented especially by using a piezoelement as the sensor element.

In particular, the signals can be evaluated by the pressure load on the outside door handle being detectable. When the second signal occurs in time before the first signal—preferably within a certain time window—this is evaluated as a pressure load and for example a corresponding locking signal is produced or made available. The detection of the pressure load or the locking signal is used especially to lock the motor vehicle door lock which is assigned to the outside door handle and preferably all motor vehicle door locks.

The aforementioned detection of a pressure load of the outside door handle—especially pressing on the outside door handle in the area of an especially marked section or the like—can also be implemented independently of the generation and evaluation of two signals provided as claimed in the invention. In particular, another also independently implementable idea of this invention consists in that in a preferably stationary outside door handle the pressure load can be detected and, depending on it, the motor vehicle door locks can be locked, closed by motor, and/or other motor vehicle functions started or executed.

Another important aspect of this invention is to provide an outside door handle arrangement with a preferably stationary outside door handle so that both a tensile load and also a pressure load can be detected especially by means of a single sensor.

Other aspects, properties, features and advantages of this invention derive from the following explanation of preferred embodiments which are shown in the drawings.

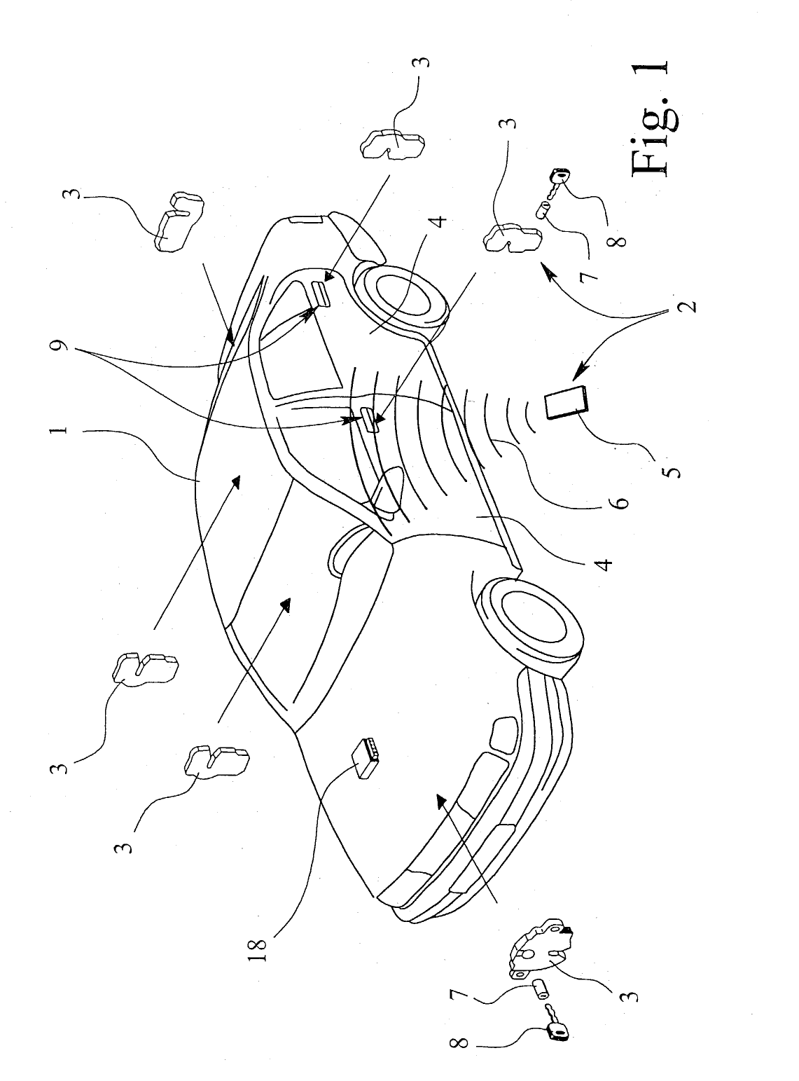

FIG. 1 shows a schematic perspective view of a motor vehicle with a motor vehicle door lock system as claimed in the invention;

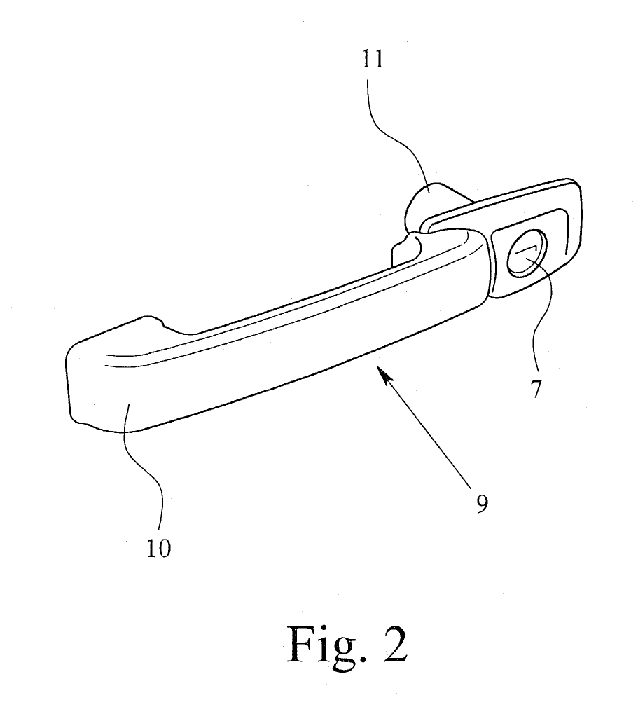

FIG. 2 shows an outside door handle arrangement of the motor vehicle door lock system as shown in FIG. 1;

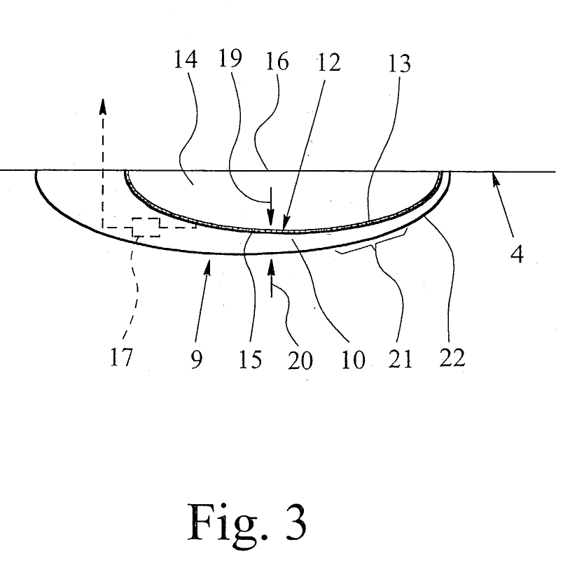

FIG. 3 shows a schematic overhead view of an outside door handle arrangement;

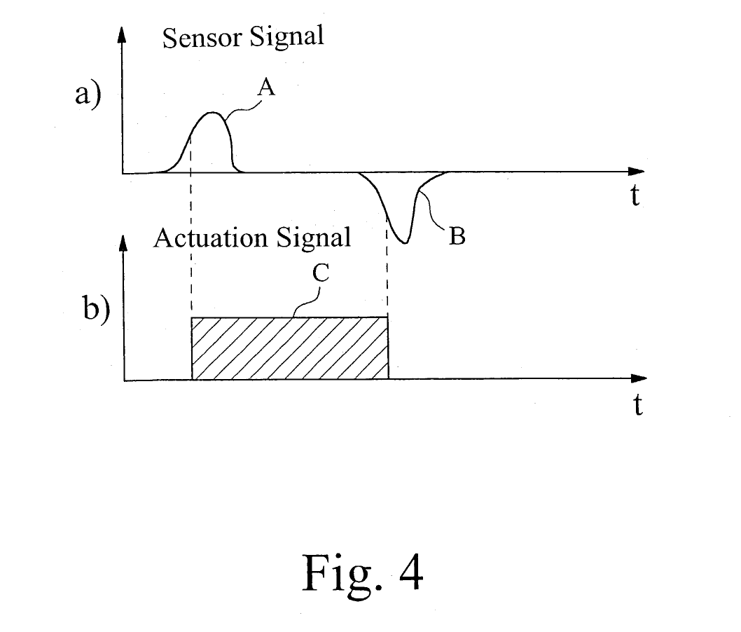

FIGS. 4a,b show schematic signal diagrams for detection of a tensile load;

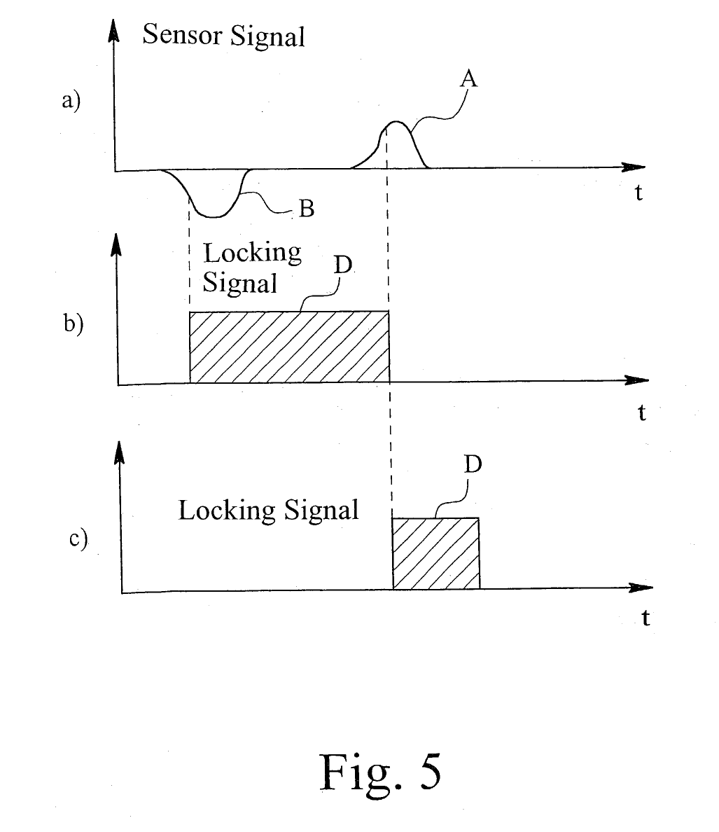

FIGS. 5a,b show schematic signal diagrams for detection of pressure load; and

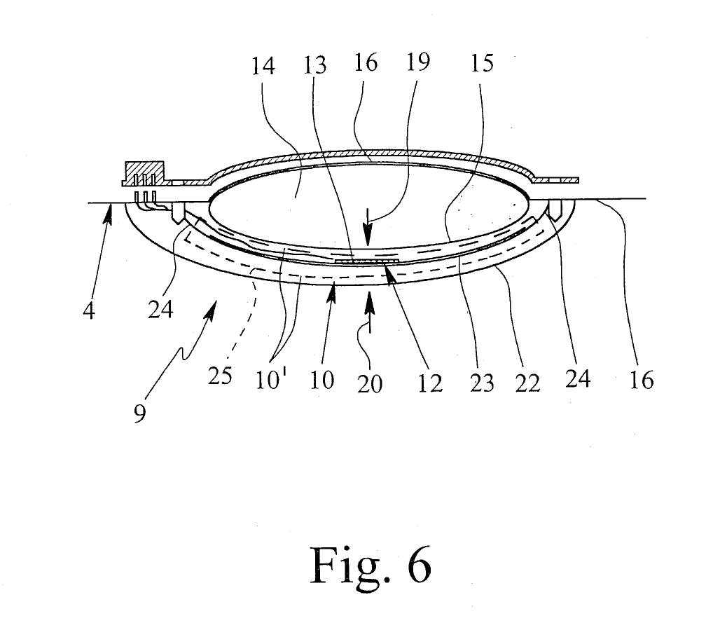

FIGS. 6-10 show schematic sections of other outside door handle arrangements.

The same reference numbers are used for the same or similar parts, and the corresponding or comparable advantages and properties arise, even if a repeated description is omitted.

FIG. 1 schematically shows a motor vehicle 1 with a motor vehicle door lock system 2 as claimed in the invention. The motor vehicle door lock system 2 has especially several vehicle locks 3, especially for the vehicle doors 4, the rear hatch, the hood and the like, with installation positions which are shown schematically in FIG. 1.

Preferably each motor vehicle lock 3 can be locked and unlocked by a motor, especially an electric motor, by means of a known central interlock system or a central interlock drive. In the version as an electric lock, which is provided especially in the motor vehicle locks 3 of the vehicle side doors 4, each motor vehicle lock 3 additionally has the possibility of motorized opening, therefore lifting of the detent pawl which is not shown, by means of an opening drive which is not shown. In this case, locking and unlocking can also be accomplished accordingly only using circuitry.

The motor vehicle door lock system 2 is preferably equipped with a “passive entry” function. Here a passive entry function is defined especially as automatic, vehicle-side data interrogation or identification of an operator-side data medium, a transponder 5 or the like, in order to ascertain whether an operator approaching the motor vehicle 1 or an operator already about to open the vehicle 1 or the vehicle door 4 is authorized for access. This is generally checked by the corresponding electronics of the motor vehicle 1. With the corresponding authorization of the operator, ordinarily automatic unlocking either of a central interlock system, of the door lock 3 of the driver-side door 4, or at least of the lock 3 of the door 4 being approached by the operator or the outside door handle the operator is touching or activating takes place.

In the embodiment the motor vehicle door lock system 2 comprises a data medium which is made as a “passive entry” chip card or other data medium or a transponder 5 which is carried by an operator who is not shown, and which is used as an “electronic key”. Thus data interrogation or identification of the data medium or transponder 5 which is triggered on the motor vehicle-side, as indicated by the signal waves 6, can be carried out and the access authorization of the operator can be checked. With the corresponding access authorization preferably all the motor vehicle locks 3 are unlocked by means of the central interlock system which is not shown or the like.

If necessary one lock cylinder 7 at a time for actuation with a mechanical key 8 is assigned to the motor vehicle lock 3 of the driver's door and the hood lock. Thus the motor vehicle lock 3 of the driver's door can be mechanically actuated or unlocked in an emergency with the key 8 and opened. There can be the corresponding emergency unlocking or emergency opening if necessary also for the motor vehicle door locks 3 of the other doors 4.

One outside door handle arrangement 9 is assigned to at least each motor vehicle door lock 3 of the motor vehicle side doors 4, as shown in FIG. 1. FIG. 2 shows the outside door handle arrangement 9 of the driver's door with an integrated lock cylinder 7 which is supported for example in a guide element 11. But the lock cylinder 7 and its guide element 11 can also be omitted if necessary.

The outside door handle arrangement 9 furthermore has an outside door handle 10 which is made stationary and which has no moving parts, such as a movable actuating and opening lever or the like. A bow-shaped handle is shown, a flap-shaped handle could likewise be used.

The outside door handle arrangement 9 can moreover comprise an adjacent door area which is not shown in FIG. 2, especially when the outside door handle arrangement 9 together with this adjacent door area is inserted as a unit into the assigned motor vehicle door 4. This is not absolutely necessary based on the stationary outside door handle 10. Rather a so-called rebound plate of the outside door handle arrangement 9 can also be omitted and instead the engagement space can be defined or formed directly by the assigned motor vehicle door 4 on the one hand and the outside door handle 10 on the other.

FIG. 3 shows in a schematic overhead view an outside door handle arrangement 9 which is described for example as with regard to FIG. 2, but can also be made without the lock cylinder 7.

In the outside door handle arrangement 9, as is shown in FIG. 3, a sensor 12 is assigned to the outside door handle 10. Especially here a force-sensitive or pressure-sensitive sensor element 13 is located on the outside door handle 10, as shown in FIG. 3, or is connected to it or integrated into it in some other way.

The sensor element 13 is especially a piezoelement in the aforementioned sense.

The sensor 12 or the sensor element 13 has a minimum, or, especially when using a piezoelement, no energy demand at all, so that there is a power demand which is small anyway for the evaluation which is especially continually carried out again and again for checking whether touching or actuation of the outside door handle 10 has been detected.

The outside door handle 10 bounds or defines an engagement space 14 for the hand of the operator which is not shown. The “engagement space” here is defined accordingly especially as the space in which the hand of an operator which is not shown preferably fits to actuate the outside door handle 10.

The sensor element 13 in the embodiment as shown in FIG. 3 is located on the inside wall or the inner side 15 of the outside door handle 10 facing the engagement space 14. In particular, the sensor element 13 covers the inside 15 and/or the adjoining areas of the. outside door handle 10 over a large area, preferably essentially completely.

Alternatively or in addition, especially depending on the execution of the outside door handle 10, the sensor element 13 can also be located on another actuating surface which is conventionally grasped by the hand of the operator for actuating the outside door handle 10 and optionally in surface areas bordering it. This applies especially when the outside door handle 10 does not bound or define an engagement space 14.

If necessary, on the inside 15 or the actuating surface there can also be several pressure-sensitive sensor elements 13 of the sensor 12, therefore for example several (individual) piezocrystals or elements, optionally distributed, adjacent to one another and/or spaced apart. This can be a good idea especially with respect to redundancy aspects so that even with a possible failure of the sensor element 13 the desired detection of contact or actuation can take place.

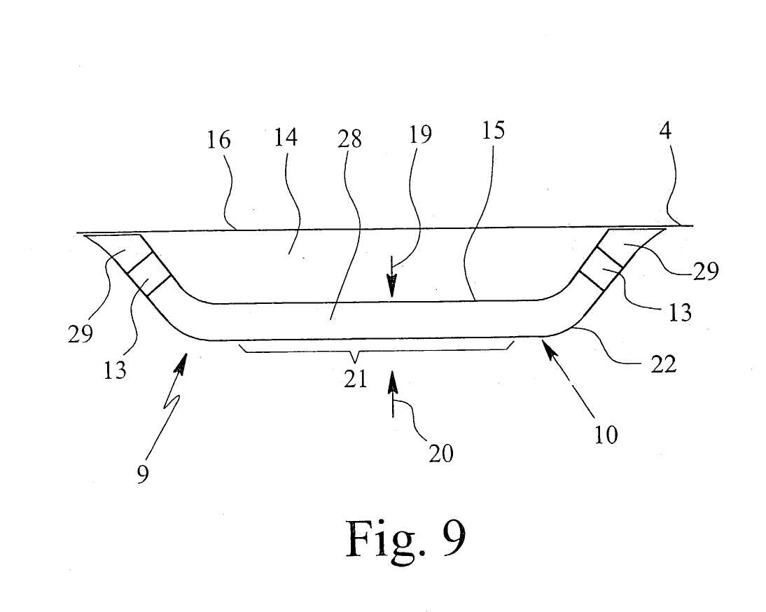

Alternatively or additionally to the arrangement of the sensor element 13 on a surface area—such as the inner side 15 or other actuating surface of the outside door handle 10, at least one sensor element 13 can also be located in the area of the support or attachment of the outside door handle 10 on an assigned door area 16 shown schematically in FIG. 3 or on another part of the outside door handle arrangement 9 and/or on or in the outside door handle 10, especially in a area of especially great transverse and/or shear stresses, preferably in an execution of the outside door handle 10 optimized in this respect, such as relatively high deformability, or can be connected to the outside door handle 10 such that the action of a force or a pressure on the outside door handle 10 is transferred from the outside door handle 10 to at least one sensor element 13 and can be detected as touching or actuation of the outside door handle 10. One such action is explained below with reference to FIG. 9.

Based on the execution of the motor vehicle door lock 3 which is assigned to the outside door handle arrangement 9 with a motorized opening drive the outside door handle 10 is made stationary, i.e. it is rigidly connected to the assigned motor vehicle door 4 or the assigned door area 16 or other parts of the outside door handle arrangement 9.

Preferably an evaluation unit or electronics 17 is assigned to the sensor 12, as indicated in FIG. 3, and is at least partially, especially completely integrated into the outside door handle arrangement 9 or the outside door handle 10.

Alternatively or in addition, the evaluation electronics 17 can be at least partially integrated into an assigned motor vehicle door or central motor vehicle or control electronics 18 of the motor vehicle 1 which is shown in FIG. 1.

When the hand of an operator which is not shown is moved into the engagement space 14 and grasps the outside door handle 10, the hand touches the sensor element 13 and applies a certain load to the sensor element 13. This leads to a corresponding change of the measurement signals and/or characteristics of the sensor 12 which can be evaluated as contact and/or actuation of the outside door handle 10. In particular a corresponding signal is output from the evaluation electronics 17, for example to the central motor vehicle electronics 18.

According to one preferred development, the sensor 12 and the optional evaluation electronics 17 are made such that it is possible to differentiate between initial touching and actual activation of the outside door handle 10 by the hand of an operator which is not shown. In particular, the intensity of the measurement signal change at the sensor 12, therefore for example the intensity of the force load or pressure load of the sensor element 13, is detected and evaluated. Here too the increase of the load over time and/or the time interval between exceeding certain response thresholds can also be considered in order for example to detect the conventional rising of measurement values or changing of measurement values during the normal course of touching and subsequent activation of the outside door handle 10.

The detection or evaluation of actuation of the outside door handle 10—therefore the sensing of actuation—is detailed below with reference to the schematic diagrams from FIG. 4.

FIG. 4a) shows by way of example the behavior of the signal which has been prepared or output by the sensor 12 or the sensor element 13. When an operator who is not shown touches or actuates the outside door handle 10—therefore pulls it—this is registered by the sensor 12 or the sensor element 13 and output as a first signal A. In the preferred use of a piezoelement as a sensor element 13 or another sensor element which is sensitive or reacts only to changes only a brief first signal A arises, as shown.

When the outside door handle 10 is released, a second signal B is output, as is likewise indicated in FIG. 4a). The second signal B is also present only for a short time.

The start and end of actuation of the outside door handle 10 are derived from the first signal A and the second signal B. Accordingly, depending on the detection of the first signal A and the detection of the second signal B an actuation signal C is determined, as shown for example or schematically in FIG. 4b). Depending on the actuation signal C, the motor vehicle door lock 3 assigned to the actuated outside door handle 10 is opened by motor, if the motor vehicle door lock 3 is already unlocked and/or a corresponding access authorization is present or is detected by the control electronics 18.

The unlocking of the motor vehicle door lock 3 can also be switched by actuating the outside door handle 10. For example, it can be provided that by simply briefly pulling on the outside door handle 10 the motor vehicle door lock 3 is unlocked and by pulling for a longer time or pulling twice motorized opening of the motor vehicle door lock 3 takes place. It can be assumed in any case that there is corresponding access authorization.

The evaluation and preparation of an actuation signal C as claimed in the invention can take place especially by the evaluation electronics 17. But evaluation can alternatively also take place in the control electronics 18 or in some other means of the motor vehicle 1.

Depending on the configuration, it is not necessary for the actuation signal C to be produced or output. Rather the actuation signal C can also be defined as the logic state of the control, especially of the control electronics 18 or the like. Depending on this logic state the assigned motor vehicle door lock 3, as already explained, can be locked and unlocked, opened and closed.

The motor vehicle door lock 3 is opened especially by the detent pawl of the motor vehicle door lock 3 which is not shown being raised during the opening state or being moved into a non-blocking state.

In the embodiment the first signal A and the second signal B have opposite polarities and opposite time responses. This facilitates detection. Advantageously this behavior occurs in the preferably used piezoelement and capacitive evaluation.

Detection can take place for example by detecting a certain (positive or negative) threshold value of a (positive or negative) rate of change—therefore time derivation—and/or an integral value or the like being exceeded in the signal made available by the sensor 12 or the sensor element 13 and by its being evaluated as the first signal A or the second signal B. Of course here other suitable detection criteria or algorithms can also be used.

The actuation sensing as claimed in the invention is not limited to the first signal A and the second signal B having opposite polarities or time response. This is advantageous, but not necessary in the corresponding detection criteria.

Furthermore, the actuation sensing as claimed in the invention can also take place when the sensor 12 or the sensor element 13 makes available a signal which for example is present for the entire duration of actuation of the outside door handle 10, optionally with certain fluctuations. This is the case for example in a sensor 12 or sensor element 13 in which the sensor signal is proportional to the acting force or the acting pressure. The first signal A can be detected for example as the edge—great rise over time—of the sensor signal and the second signal B as the opposite edge—great drop over time—of the sensor signal.

In addition, it should be pointed out that actuation sensing can also be used to control other motor vehicle functions and to activate other motor vehicle controls. Preferably the corresponding control signals such as the actuation signal C are output by the evaluation electronics 17 or other electronics, such as the control electronics 18.

So far primarily only the detection of touching or actuation of the outside door handle 10 has been addressed. In this conventional touching or actuation of the outside door handle 10 usually a tensile load, as is indicated by the arrow 19 in FIG. 3 and FIGS. 6 to 10, is applied to the outside door handle 10. Touching of the outside door handle 10 therefore takes place at least essentially on the inner side 15 of the outside door handle 10 facing the engagement space 14. The actuation or tensile load 19 is accordingly pointed away from the assigned motor vehicle door 4 or the assigned door area 16.

Another important, also independently feasible aspect lies in that a pressure load on the outside door handle 10—indicated essentially by the arrow 20—can be detected especially in addition. Especially pressing, for example of the hand of an operator which is not shown, on the outside door handle 10 in the preferably marked area 21 on the outside 22 or other suitable area of the outside door handle 10 can be detected. The pressure load 20 can be detected in addition or alternatively to detection of the tensile load 19.

In particular, the detection of a pressure load can take place by a corresponding evaluation of the signals A and B which have already been used to detect the tensile load 10, as shown in FIG. 5. When the second signal B occurs first and afterwards the first signal A, especially within a predetermined time window or interval, as indicated in FIG. 5a), this can be evaluated as a locking signal D as shown in FIG. 5b). The locking signal D however can also be produced or output only after detection of the first signal A within a time window which is not shown, as in the case as shown in FIG. 5c). FIG. 4 illustrates complete signal generation in conjunction with FIG. 5. Signal evaluation in the control electronics leads to the control versions which are then desired.

FIG. 4 shows clearly that the output signal “pull”, called the actuation signal C, is reset either after a predefined time window or by the door handle relief signal, signal B. Accordingly FIG. 5 shows that the output signal “pressure”, therefore the closing signal D, is reset after acceptance of the command or is reset after release of the outside door handle 10 by the signal A.

But, as already explained, detection of a pressure load 20 of the outside door handle 10 or its preferably especially sensitive section 21, which load is sufficient for executing a function and which optionally exceeds a predetermined response threshold, can also conventionally take place in some way other than by detection and evaluation of the signals A, B, for example by means of the sensor 12 or an additional sensor.

When a pressure load 20 is detected or when the closing signal D is present it is provided that the assigned motor vehicle door lock 3 or especially all the motor vehicle door locks 3 are locked, therefore especially a central interlock which is not shown or the like is activated. When the motor vehicle door locks 3 are made as locks which can be opened by motor or electric locks, locking can also take place if necessary solely using circuity.

Preferably the outside door handle arrangement 9 or the outside door handle 10 is made such that the sensor 12 can sense touching or actuation/tensile load 19 and also a pressure load 20, overall therefore only one sensor 12 is necessary. If necessary however there can also be several sensors 12 and/or sensor elements 13 with respect to redundancy aspects and/or for selective detection of a tensile load 19 or a pressure load 20.

In the embodiment shown in FIG. 3, if there is detection of a pressure load 20 at all, the outside door handle 10 must be made elastically deformable enough so that under a pressure load 20 the corresponding deformation of the sensor 12 or its sensor element 13 can be detected.

In the embodiment as shown in FIG. 6 the outside door handle 10—as in all the embodiments described here—is made preferably at least essentially stationary. The outside door handle 10 therefore, even in a multipart execution, has no moving parts in the sense of a switch, button, or the like. This moreover enables a simplified structure of the outside door handle arrangement 9, since movable support of parts or the like is eliminated.

The outside door handle 10 or at least parts or sections of it is or are elastically deformable such that especially in the case of the embodiments as shown in FIGS. 6 to 10 both a tensile load and also a pressure load 20 can be detected.

In the embodiment as shown in FIG. 6 the outside door handle 10 is made in several parts, here formed from two outside door handle parts 10′.

Within the outside door handle 10 there is a preferably strip-shaped support 23 to which the sensor 12 or its sensor element 13 is assigned. In particular, as the sensor element 13 a piezoelement is connected to the support 23 and optionally located on it. For example, the support 23 can have a corresponding recess so that it is possible to act on the sensor element 13 from both sides, or there can be a sensor element 13 on both sides of the carrier 23.

The support 23 is preferably securely connected to the outside door handle 10 only in opposing end areas 24 and extends otherwise at least essentially within the cavity 25 formed in the outside door handle 10. The support 23 is made strip- shaped and extends preferably roughly over the entire length of the outside door handle 10 or at least an essential part of it. The support 23 is made preferably rigidly, at least in relation to the other outside door handle 10 or its parts 10′. It consists essentially of metal, but can also be produced from plastic.

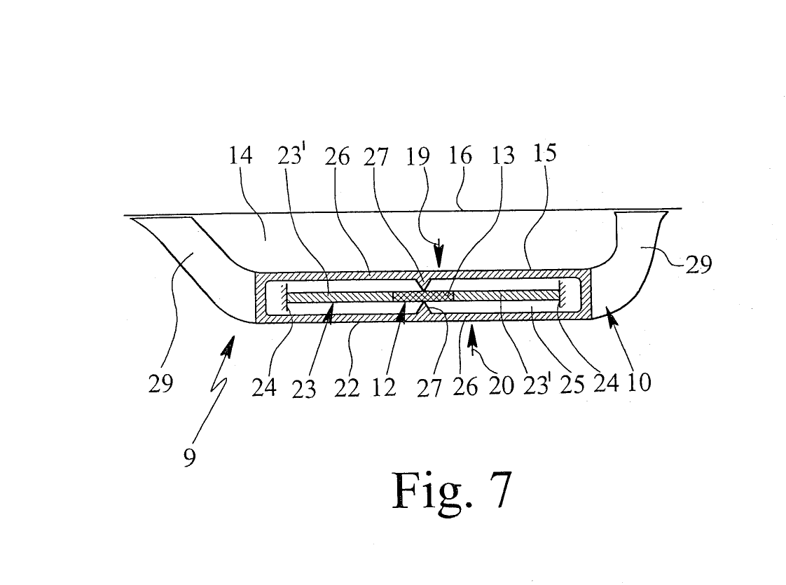

Very good response behavior is achieved especially by the fact that according to the schematic as shown in FIG. 7 elastically deformable or impressible side walls 26 of the cavity 25 or of the outside door handle 10 can act directly or via the projections 27 on the sensor 12 or its sensor element 13 with corresponding load on the outside door handle 10. In particular, application of force over a very small area, essentially at a point, in the limiting case leads to especially good response behavior even when using a piezoelement as the sensor element 13. But for example a strain gauge or the like can also be used as the sensor element 13 if necessary.

Preferably the projections 27 are made hemispherical, pin-like, in the shape of a truncated cone, or conically. Thus application of force over a very small area and thus a high pressure are achieved; this promotes good response behavior.

The above described structure leads to the fact that at least partial deformation of the outside door handle 10 with high response sensitivity can be detected, its being possible to distinguish between a tensile load 19 and a pressure load 20.

As shown in FIG. 7, the sensor 12 or the sensor element 13 can also be located and held between two sections or parts 23′ of the support 23. But a sandwich structure with a continuous support 23, as in the representations in FIG. 6, are also possible.

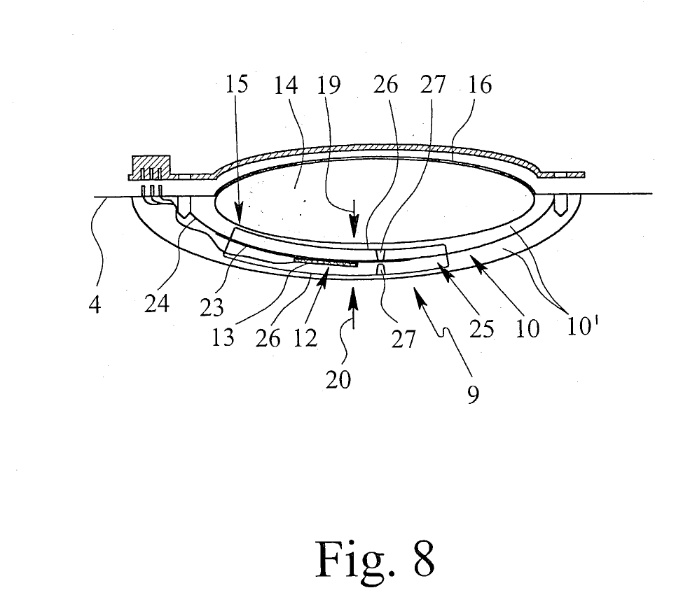

FIG. 8 shows another embodiment of the outside door handle arrangement 9 or of outside door handle 10 which is very similar to FIGS. 6 and 7. Here there is an asymmetrical arrangement of the sensor 12 or its sensor element 13. There is no direct action of the side walls 26 and projections 27 on the sensor element 13, rather this action takes place indirectly via the support 23. Accordingly, here the sensor element 13 when the outside door handle 10 is deformed is exposed to bending stress and/or elongation stress or compression stress. This can of course also be the case in the embodiment as shown in FIGS. 6 and 7. Accordingly then for example a strain gauge or the like can be used as the sensor element 13.

FIG. 9 shows another embodiment. Here at least one sensor element 13, especially a piezoelement or the like, is integrated into the outside door handle 10 such that when the outside door handle 10 is deformed, especially when a tensile load 19 or a pressure load 20 is applied to the middle part 28 of the outside door handle 10, a sufficiently high force and/or deformation is applied to the sensor element 13 in order to ensure reliable detection of the tensile load 10 or pressure load 20. In particular, in the embodiment shown the middle part 28 is held in the area of the ends 29 of the outside door handle 10 each by one sensor element 13. Of course other structures are also possible here.

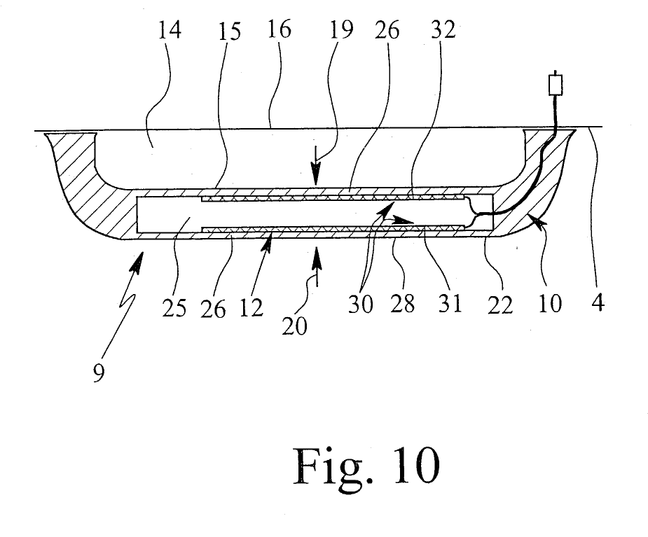

FIG. 10 shows another embodiment. Here the sensor 12 has a least one electrode arrangement 30 as the sensor element 13. The electrode arrangement 30 in the embodiment shown comprises two electrodes 31 and 32 which are located for example in the area of the opposing inside walls of the outside door handle 10. In particular, the electrodes 31, 32 can be made by metal foils on the inner sides of the side walls 26 which can be elastically deformed or which can be depressed. Preferably the electrodes 31 and 32 are arranged such that one electrode 31 is adjacent to the outer side 22 of the outside door handle 10 or of the section 21 and the other electrode 32 is adjacent to the inside 15 of the outside door handle 10 or to the engagement space 14. In particular the electrodes 31, 32 extend transversely to the direction of the tensile load 19 or the pressure load 20 which is to be detected.

When the outside door handle 10 or a side wall 26 or the outside door handle 10 is deformed under a tensile load 19 or pressure load 20, the distance of the electrodes 31, 32 changes. Accordingly especially a change of capacitance takes place. The electrode arrangement 30 therefore forms primarily a capacitive sensor in this embodiment. But the electrode arrangement 30 can also work differently or can also be evaluated differently. For example, depending on the deformation of the outside door handle 10, other electrical characteristics, such as inductance, resistance, impedance or the like can also be changed and evaluated to detect a tensile or pressure load 19, 20. Depending on the manner of operation and the material used with the corresponding, suitable, for example dielectric or magnetic, properties the cavity 25 can also be omitted.

In the embodiment the electrode arrangement 30 is not suited for differentiating between a tensile load 19 and a pressure load 20. There can be for example another electrode which is not shown for differentiation. Alternatively or in addition, with a suitable material selection and with a suitable structure specific changes of electrical/magnetic characteristics can be achieved such that it is possible to differentiate between a tensile load 19 and a pressure load 20 even with only two electrodes 31, 32.

Another advantage of the electrode arrangement 30 or when using a capacitive sensor 12 to sense actuation of the outside door handle 10 is that at the same time proximity sensing can also be accomplished. For example, with the electrode arrangement 30, by changing the electrical capacitances it can be detected when the hand (not shown) of an operator reaches into the engagement space 14. Accordingly therefore only one sensor 12 is necessary both for actuation sensing and also proximity sensing.

In addition, it should be pointed out that the electrode arrangement 30 can also make available signals comparable or similar to signals A, B, as shown in FIG. 4. Therefore, a corresponding evaluation is possible.

Alternatively or in addition to the electrodes 31, 32 there can also be strain gauges, piezoelements or the like, especially on the inside walls.

Of course, the aforementioned versions of the outside door handle arrangement 9 or of the outside door handle 10 if necessary can also be combined with one another. For example, different or several sensors 12 or different or several sensor elements 13 can be assigned to the outside door handle 10 and especially integrated into them.

1. Motor vehicle door lock system (2) with a motor vehicle door lock (3), an outside door handle (10) which is assigned to the motor vehicle door lock (3), which is made stationary, and which has no moving parts, and a sensor (12) assigned to the outside door handle (10) for detection of touching and/or actuation of the outside door handle (10) by the hand of the operator,
and when the outside door handle (10) is touched or actuated a first signal (A) and when released a second signal (B) can be produced and output by the sensor (12) and the two signals (A, B) can be evaluated as the start and end of actuation of the outside door handle (10), and/or
a pressure load (20) which acts on the outside door handle (10), at least in the area of one section (21) of the outside door handle (10), can be detected and can be evaluated as a locking signal (D).

2. Motor vehicle door lock system as claimed in claim 1, wherein an actuation signal (C) can be produced and output, the first signal (A) determining the start and the second signal (B) determining the end of the actuation signal (C) and especially the motor vehicle door lock (3) can be opened depending on the actuation signal (C), especially if the motor vehicle door lock (3) is already unlocked and/or a corresponding access authorization is present or can be detected.

3. Motor vehicle door lock system as claimed one of the preceding claims, wherein the motor vehicle door lock (3) can be opened by
a motor and wherein there is evaluation and/or control electronics (17, 18) which causes opening of the motor vehicle door lock (3) depending on the first signal (A) and closing depending on the second signal (B), especially if the motor vehicle door lock (3) is already unlocked and/or a corresponding access authorization is present or can be detected.

4. Motor vehicle door lock system as claimed one of the preceding claims, wherein the first signal (A) can be detected with a tensile load on the outside door handle (10) and/or the second signal (B) can be detected with a pressure load on the outside door handle (10) and wherein when the second signal (B) occurs, especially within a definable time window, before the first signal (A) a pressure load on the outside door handle (10) can be detected and this can be evaluated as the locking signal (D).

5. Motor vehicle door lock system as claimed one of the preceding claims, wherein inside touching and/or tensile loading (19) of the outside door handle (10) by the hand of an operator can be detected.

6. Motor vehicle door lock system as claimed one of the preceding claims, wherein there is a section (21) on the outside (22) of the outside door handle (10), especially on the side (21) of the outside door handle (10) facing away from the assigned motor vehicle door (4).

7. Motor vehicle door lock system as claimed one of the preceding claims, wherein a motor vehicle door lock (3) which is assigned to the outside door handle (10) can be locked when the locking signal (D) is detected.

8. Motor vehicle door lock system as claimed one of the preceding claims, wherein all the motor vehicle door locks (3) can be locked when the locking signal (D) is detected.

9. Motor vehicle door lock system as claimed one of the previous claim, wherein when inside touching and/or tensile loading (19) of the outside door handle (10) is detected, the motor vehicle door lock (3), especially all the motor vehicle door locks (3), can be unlocked, especially if a corresponding access authorization is present or can be detected.

10. Motor vehicle door lock system as claimed one of the preceding claims, wherein when inside touching and/or tensile loading (19) of the outside door handle (10) is detected, the motor vehicle door lock (3) can be opened by motor, especially if the motor vehicle door lock (3) has already been unlocked and/or a corresponding access authorization is present or can be detected.

11. Motor vehicle door lock system as claimed in one of the preceding claims, wherein the outside door handle (10) and the sensor (12) are made such that the sensor (12) can detect inside touching and/or tensile loading (19) of the outside door handle (10) as well as pressure loading (20) of the outside door handle (10).

12. Motor vehicle door lock system as claimed in one of the preceding claims, wherein the motor vehicle door lock (3) can be opened by motor and/or electrically.

13. Motor vehicle door lock system as claimed one of the preceding claims, wherein the sensor (12) has a sensor element (13) which is located on the outside door handle (10), which is connected to it, or which is integrated into it.

14. Motor vehicle door lock system as claimed one of the preceding claims, wherein the sensor (12) has a sensor element (13) which is sensitive to pressure or force.

15. Motor vehicle door lock system as claimed one of the preceding claims, wherein the sensor (12) has several sensor elements (13) which are sensitive to force or pressure, which are located especially on the outside door handle (10) and/or which are connected to it.

16. Motor vehicle door lock system as claimed one of the preceding claims, wherein the sensor (12) or the sensor element (13) of the sensor (12) is made such that it converts changes of force and/or pressure into electrical signals or changes of at least one electrical characteristic, especially the first signal (A) and the second signal (B) having opposite polarity or direction of change and opposite time response.

17. Motor vehicle door lock system as claimed one of claims 13 to 16, wherein the sensor element (13) is made as a piezoelement.

18. Motor vehicle door lock system as claimed one of the preceding claims, wherein the sensor (12) has a sensor element (13) which is sensitive to touching or proximity.

19. Motor vehicle door lock system as claimed one of claims 13 to 18, wherein the sensor element (13) is located at least essentially solely in the area of the inner side (15) of the outside door handle (10) facing the engagement space (14) which is bordered by the outside door handle (10).

20. Motor vehicle door lock system as claimed one of the preceding claims, wherein the sensor element (13) covers and/or forms the actuation surface of the outside door handle (10).

21. Motor vehicle door lock system as claimed one of the preceding claims, wherein the sensor (12) or the sensor element (13) is made and/or arranged to be at least essentially immovable.

22. Motor vehicle door lock system as claimed one of the preceding claims, wherein the outside door handle (10) is made and/or arranged to be at least essentially rigid or elastically deformable and/or wherein the sensor (12) is made stationary or immovable.

23. Motor vehicle door lock system as claimed one of the preceding claims, wherein the motor vehicle door lock system (2) has at least one outside door handle arrangement (9) as claimed in one of claims 24 to 31.

24. Outside door handle arrangement (9) for a motor vehicle door lock system (2), especially as claimed in one of the preceding claims, the outside door handle arrangement (9) having a stationary outside door handle (10) and a sensor (12) assigned to the outside door handle (10) for detecting inside touching and/or
a tensile loading (19) of the outside door handle (10) by the hand of an operator, the outside door handle (10) and the sensor (12) being made such that the sensor (12) can detect inside touching and/or tensile loading (19) of the outside door handle (10) as well as pressure loading (20) of the outside door handle (10).

25. Outside door handle arrangement as claimed in claim 24, wherein the outside door handle (10) is made elastically deformable.

26. Outside door handle arrangement as claimed in claim 24 or 25, wherein the outside door handle (10) is made in several parts.

27. Outside door handle arrangement as claimed in one of claims 24 to 26, wherein the outside door handle (10) is made at least essentially rigid or elastically deformable, especially has no moving parts, and/or wherein the sensor (12) is made stationary or immovable.

28. Outside door handle arrangement as claimed in one of claims 24 to 27, wherein the sensor (12) is located in a cavity (25) of the outside door handle (10).

29. Outside door handle arrangement as claimed in one of claims 24 to 28, wherein the sensor (12) has at least one sensor element (13), especially a piezoelement and/or a strain gauge.

30. Outside door handle arrangement as claimed in claim 29, wherein the sensor element (13) is located on an especially strip-shaped support (23), the support (23) preferably being connected only in opposing end areas (24) to the outside door handle (10) and/or the support (23) being made rigid.

31. Outside door handle arrangement as claimed in one of claims 24 to 30, wherein the sensor (12) has an electrode arrangement (30), and deformation of the outside door handle (10) as a result of a tensile or pressure load (19, 20) can be detected by the sensor (12) and/or assigned electronics (17, 18), especially by detection of the change of the capacitance, inductance and/or impedance of the electrode arrangement (30).

32. Process for controlling a motor vehicle door lock system (2) with a motor vehicle door lock (3) and a stationary outside door handle (10) which is assigned to the motor vehicle door lock (3),
touching and/or actuation of the outside door handle (10) by the hand of an operator being detected by means of a sensor (12) which is assigned to the outside door handle (10),
when the outside door handle (10) is touched or actuated a first signal (A) and when the outside door handle (10) is released a second signal (B) being produced by the sensor (12) and the two signals (A, B) being evaluated as the start and end of actuation of the outside door handle (10),
the sensor (12) converting changes of force and/or pressure into electrical signals or changes of at least one electrical characteristic, and the first signal (A) and the second signal (B) being detected by evaluation of the time response and/or time derivation of the sensor signals,
when the first signal (A) is detected the motor vehicle door lock (3) being opened by a motor until the second signal (B) is detected and/or
the first signal (A) being detected with a tensile load (19) on the outside door handle (10) and when the second signal (B) occurs before the first signal (A) a pressure load (20) acting on the outside door handle (10), at least in the area of one section (21) of the outside door handle (10), being detected and this being evaluated or used as a locking signal (D) for locking the motor vehicle door lock (3).

33. Process as claimed in claim 32, wherein the first signal (A) and the second signal (B) have opposite polarity or direction of change and an opposite time response.

34. Process as claimed in claim 32 or 33, wherein upon motorized opening the detent pawl of the motor vehicle door lock (3) is lifted and/or wherein motorized opening only takes place if the motor vehicle door lock (3) is already unlocked and/or a corresponding access authorization is present or is established.

35. Process as claimed in one of claims 32 to 34, wherein when the second signal (B) occurs within a given time window before the first signal (A) a pressure load (20) on the outside door handle (10) is detected and this is evaluated or used as a locking signal (D) for locking the motor vehicle door lock (3).

36. Process as claimed in one of claims 32 to 35, wherein when a pressure load (20) is detected all the motor vehicle door locks (3) are locked.

37. Process as claimed in one of claims 32 to 36, wherein when inside touching and/or tensile loading (19) of the outside door handle (10) is detected, the motor vehicle door lock (3), especially all motor vehicle door locks (3), is or are unlocked, especially if a corresponding access authorization is present or detected.

38. Process as claimed in one of claims 32 to 37, wherein when inside touching and/or tensile loading (19) of the outside door handle (10) is detected, the motor vehicle door lock (3) is opened by a motor, especially if the motor vehicle door lock (3) is already unlocked and/or a corresponding access authorization is present or is detected.
